(19) United States
(12) Patent Application Publication
(10) Pub. No.: US 2005/0028389 A1
(43) Pub. Date: Feb. 10, 2005

(54) Cvd diamond cutting insert

(76) Inventors: Christopher John Howard Wort, Wantage (GB); Kirsten Winkler, Bracknell (GB); Mark Robin McClymont, Warfield (GB); Adrian Charles Beale, Foxdale (GB); Wilhelmus Gertruda Maria Nelissen, Bj Blitterswyck (NL)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/479,974

(22) PCT Filed: Jun. 11, 2001
(86) PCT No.: PCT/IB02/02143

(30) Foreign Application Priority Data
Jun. 12, 2001 (GB) 0114302.3

(51) Int. Cl. B26B 21/54

(52) U.S. Cl. 30/346.54

(57) ABSTRACT

A blade, particularly a razor blade, comprises a layer of CVD diamond having a monolithic elongate cutting edge.

### BACKGROUND OF THE INVENTION

This invention relates to a CVD diamond cutting insert and more particularly to a CVD diamond razor blade.

Cutting human hair by shaving is a demanding and unique application. The hairs themselves do not cut easily, but can bend and then be pulled by an unsuitable or blunt blade causing pain. The most important region of the razor blade is generally accepted to be the first 40-150 μm from the cutting edge, which must cut cleanly, not show permanent deformation under cutting loads, and yet be as thin and frictionless as possible.

Conventional razor blades are made from steel and go blunt during the hair shaving process. Techniques to improve the longevity of steel blades include the application of hard coatings and the treatment of the steel by, for example, ion implantation. Whilst these enhancement techniques do work, the improvement in longevity (the length of time the blade remains sharp) is only modest.

In U.S. Pat. No. 4,720,918 it is stated that in conventional steel razor blades the effective full angle at a distance of about 40 μm back from the tip of the razor needs to be kept as low as possible consistent with a sufficiently strong edge, and in particular this angle is generally 20° or less. This reduces the drag on the hair being cut which otherwise results when using a wider blade angle, as the wider blade requires to open a wide wedge angle in the hair as it cuts through. This same U.S. patent suggests that for materials harder than steel, such as sapphire, titanium carbide and diamond, the blade can be made thinner with smaller angles at the cutting edge of the blade. No working examples of such blades are provided.

It has been recognised that harder materials than steel, such as ceramics, generally make longer lasting blades. The harder the material the longer the blade will last, provided the edge does not damage or chip. FR 2 536 691 recognises this fact and shows several designs of diamond razor blades made from multiple, single crystals of diamond each of which has a sharpened edge. The use of multiple edges is however limited, as it requires careful fabrication and alignment to present a single continuous straight edge without steps in the regions where adjacent crystals are joined.

WO 93/00204 describes a razor blade which includes a substrate with a wedge-shaped cutting edge and a layer of diamond or diamond-like material coating the substrate and more particularly coating the cutting edge. The substrate or core of the blade provides the rigidity and resilience required and the wear resistance is obtained from the diamond coating. In general these coatings are very thin, ensuring that the diamond is supported by the substrate material right to the cutting edge and that the coating does not adversely increase the cutting edge radius.

### SUMMARY OF THE INVENTION

According to the present invention, a blade comprises a layer of CVD diamond having a monolithic elongate cutting edge.

Essential to the blade of the invention is that the layer is made of CVD diamond and it has a monolithic elongate cutting edge. The cutting edge is monolithic and uninterrupted by bonding regions such as those in the blade of FR 2 536 691. The cutting edge will generally be at least 10 mm in length and preferably at least 20 mm in length. When the blade is a razor blade, the length will typically be in the range 30 to 45 mm.

The shape of the layer of CVD diamond will depend on the application to which the blade is to be put. The shape, particularly in the case of razor blades, will generally be such as to provide at least one straight cutting edge and will typically be rectangular, square or triangular.

The thickness of the CVD diamond layer will again depend on the use to which the blade is to be put. In the case of razor blades, the CVD diamond layer will typically have a thickness in the range 50-400 μm, preferably 150-275 μm

CVD diamond is, as is known in the art, diamond produced by chemical vapour deposition. The diamond may be single crystal or polycrystalline.

When the blade is a razor blade, it has been found that the profile of the cutting edge tip and region of the layer leading up to the cutting edge tip is of importance. In this regard, it is preferred that the effective full angle of the blade at a distance of 40 μm from the cutting edge tip is in the range 12 to 28°, preferably in the range 15 to 25°, and more preferably in the range 17 to 23°.

The effective full angle and effective half angle of a razor blade is illustrated by the attached FIGS. 1 and 2. Referring first to FIG. 1, an asymmetric razor blade is shown and comprises a body 10 having a cutting edge region 12. The cutting edge region 12 comprises inwardly sloping surfaces 14, 16. The surface 16 has an extra facet 18 formed in it. The cutting edge tip or extreme edge of the blade is at 20.

The effective half angle of the blade is the angle formed at the intersection of a line 22 passing through the centre of the blade and a line 26 drawn from a point 24 on one of the surfaces 14, 16. Point 24 is characterised in that it also lies on a line 34 drawn normal to line 22 typically at a distance of 40 μm from the tip 20 of the blade. For the surface 16, the line 26 is not coincident with the surface 16. The effective half angle is the angle 28. For the surface 14, the line 26 from the point 24 is coincident with the surface 14 and the effective half angle is the angle 30. The effective full angle is the sum of the angles 28 and 30.

FIG. 2 illustrates the effective half angle and effective full angle for a symmetric blade. In this Figure, like parts to those of FIG. 1 carry like numerals. In this blade, the surface 14 also has a facet 18 formed on it. The lines 26 from the points 24 of both the surfaces 14, 16 are not coincident with these surfaces and intersect line 22 at the cutting edge tip 20. The angles 28 and 30 are the same. Thus, for a symmetric blade, the effective full angle is twice that of the effective half angles 28, 30.

According to a further aspect of the invention, the cutting edge tip of the blade of the invention preferably has a radius which is less than 60 nm, preferably less than 40 nm, more preferably less than 20 nm. Tips with a radius of less than 5 nm can be produced and used. The tip radius of the blade is identified by the numeral 32 in FIG. 1.

The invention extends to the use of a blade as described above as a razor blade in the shaving of hair from a surface of a human or of an animal.

Still further according to the invention, a razor comprises a cutting insert as described above, so mounted in a holder to present the monolithic elongate cutting edge suitable to carry out a shaving operation.

### BRIEF DESCRIPTION OF THE DRAWINGS

FIG. 1 is a side view of an embodiment of an asymmetric blade of the invention, and

FIG. 2 is a side view of an embodiment of a symmetric blade of the invention.

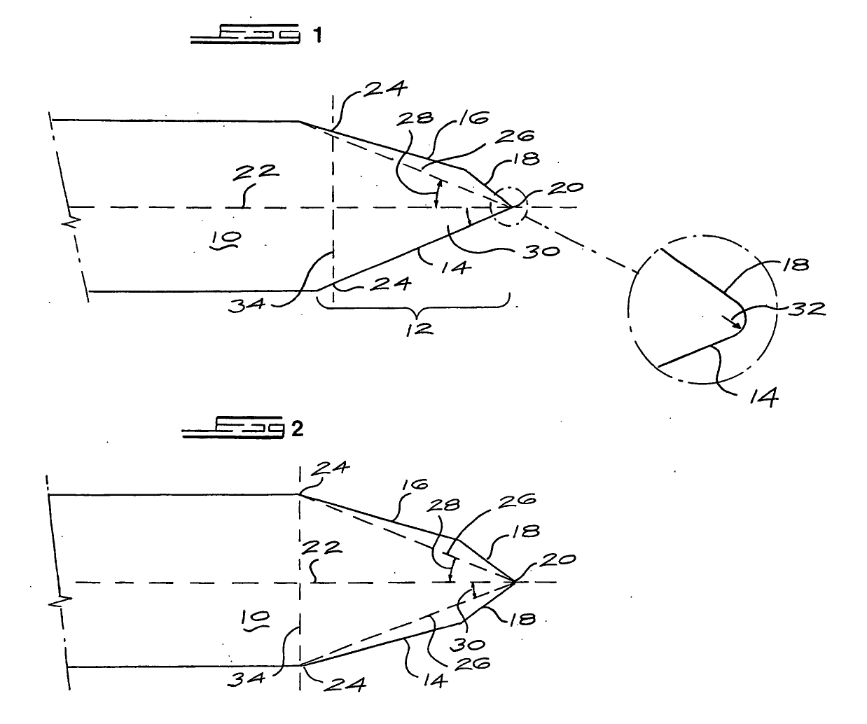

### DESCRIPTION OF EMBODIMENTS

Essential to the invention is that the cutting edge of the blade is provided by an elongate edge of a layer or sheet of CVD diamond. CVD diamond, as is known in the art, is diamond produced by chemical vapour deposition. The diamond may be single crystal or polycrystalline. Polycrystalline diamond is preferred.

The cutting edge is a monolithic elongate edge and may be of a length sufficient to allow the blade to be used as a razor blade in a shaving application. The length of the cutting edge for the razor blade will typically be in the range 30 to 45 mm.

A high degree of care is required in the preparation of the cutting edge in order to achieve the performance necessary for applications such as shaving. It has been found that the following methods are suitable to achieve this:

1) A layer of CVD diamond is grown on a substrate using methods known in the art. The layer may be single crystal, which is typically grown epitaxially on a diamond substrate, or polycrystalline and typically grown on a substrate such as Mo, W, Si, SiC or other carbide former. Furthermore, the diamond can be doped or undoped depending on the desired electrical properties which can be selected to enhance processing. Typical dopants are B, P and S, with B being the preferred option. The layer of diamond is typically grown to an average thickness of 50-300 μm thick, and may be subsequently polished on one or both sides. In the case of polycrystalline diamond layers, the polishing process may be used to remove the typically rough growth surface and produce a flat upper surface to the blade. Polishing may proceed to a highly polished finish, or to a polish of roughness of less than 100 nm Rₐ. It may also be preferable to polish the nucleation side (removing for example 5-30 μm), especially if an asymmetric blade is to be produced with the tip near the nucleation face, since the material at the nucleation surface does not generally support the preparation of a good edge.

2) The basic shape of the blade is then cut from the layer or sheet of CVD diamond, for example by a laser or by electro-discharge machining, to the desired shape, typically rectangular. In doing so, one monolithic elongate edge will generally be cut at a suitable angle, for example, to provide an elongate cutting edge. In order to avoid the shoulder or rounded edge typically formed at the point of laser entry into a diamond film, where laser cutting is used then the cutting edge is preferably formed at the exit surface of the laser from the diamond. Alternatively, one or more blanks may be cut for example by laser with orthogonal sides, stacked together at an angle, and the angle for the elongate cutting edge formed on the assembled stack by a process of lapping or polishing. The laser used for cutting or subsequent processing or both may be one of the following types: Nd:YAG, Excimer, Cu vapour, or other types of pulsed laser.

3) At the time of cutting the basic shape of the blade, the diamond layer may be freestanding, mounted in a holder, or may be attached to a substrate. In the case of polycrystalline diamond layers the substrate to which the layer may be attached may be the substrate on which the diamond was grown.

4) Laser cutting generally provides the cut surface with a degree of ripple or waviness. A method of removing this waviness is to mechanically process the cut surface using a lapping and/or polishing technique suitable for diamond. Included in this range of techniques are scaife, bonded and CVD diamond wheel polishing techniques, hot metal thinning techniques, and (particularly for doped conductive diamond) electro-discharge machining techniques. Methods of mechanically polishing diamond result in high specific loads on the cutting edge. A benefit at this stage of having the diamond glued or bonded to a substrate is that the thin diamond cutting edge is mechanically supported and edges with a lower included angle (at a point 40 μm back from the cutting edge) can be produced. Hot metal thinning can be completed using a range of materials and temperatures. Typically processes in the range of 500-1600° C. can be used, using rare earth metal thinning plates at the lower end of the temperature scale, steel plates in the mid temperature range about 1000°, and metals such as Ni and Cr at the upper temperature range. The final edge geometry can be an asymmetric blade (where one side of the cutting edge is formed by the side of the layer) or a symmetric blade (where a facet different from the side of the layer is present at each side of the cutting edge). On either one or both sides forming the actual cutting edge there may be a single facet or multiple facets at different angles, depending on the performance characteristics required.

5) At this stage the basic diamond blade geometry has been generated, and can be revealed by the removal of any substrate to which the diamond may still be attached. Preferably this is completed by chemical or electrochemical means, such as acid dissolution. Alternatively, methods such as electro-discharge machining can be used for electrically conductive substrates; the diamond may then be preferably doped or undoped depending on the details of the process. Further alternatives for substrate removal include reactive ion etching techniques, where the substrate material is preferentially etched by an ion beam. The substrate may not be removed entirely from the diamond layer, so as to provide an advantage such as mechanical support to the diamond away from the cutting edge. However, for at least the first 100 μm, preferably the first 150 μm, and more preferably the first 200 μm away from the cutting edge tip, there should be no substrate.

6) Either prior to or post substrate removal (if applicable) the diamond cutting edge can be further processed using ion beam milling techniques. In diamond it has been shown that the etch rate of diamond under an ion beam is sensitive to the angle of incidence, peaking at an angle of incidence of about 50° from normal incidence. Thus ion beam milling can be used to vary the relative size of facets in a multifaceted edge design, to provide a degree of rounding or a microfacet at the facet junction, to provide a smaller cutting edge tip radius, and to modify the surface characteristics of the diamond and in particular its frictional properties. During ion beam milling the blade may be static or moved in an oscillatory or other fashion appropriate to the results desired, and the blade may be treated by ion beam on one or both sides. Partial substrate removal (where applicable) may be used as a technique to form a mask for the ion beam milling stage and thus modify the geometry of the final cutting edge achieved after completion of the substrate removal procedures.

In the manner described above, a sharp cutting edge and, in particular, a cutting edge tip having effective full angle as described above can be achieved. In this regard, it should be noted that it is conventional to polish cutting edges on diamond surgical blades. However, for such commercially available blades the cutting edges have an effective full angle at a position 40 μm from the cutting edge tip which is larger than 30°, typically in the range 35 to 50°. As such, the cutting edges of the prior art are unsuitable for shaving applications. This type of edge on a diamond surgical blade has been developed as a result of high loads present in normal diamond polishing techniques which causes edge chipping in edges with smaller effective full angles. This edge chipping has limited diamond coated edges to large effective full angles and/or large tip radii.

The CVD diamond cutting insert of the invention has a sharp cutting edge which will remain sharp, even during extended use, due to the fact that the blade is made of pure diamond, the hardest known material. The diamond cutting edge will not rust or oxidise in any way, either during use or during storage, as diamond is chemically inert. The cutting edge will not be scratched and thus impaired by contact with any material other than diamond itself. Since there are no hard coatings involved in or at the cutting edge, there is no possibility of hard coating delamination or erosion during use, as with coated razor blades of the prior art. Lubricant coatings including metals may be used to control the level of friction between the blade and the hair and/or skin.

Examples of the Invention will now be Described

### EXAMPLE 1

A sheet of polycrystalline CVD diamond was removed from a tungsten substrate on which it was grown. The sheet had opposite flat and parallel surfaces which were processed by removing the rough growth surface on the diamond using a lapidiary-based technique. Then both surfaces were polished to a roughness of less than 100 nm Ra, removing at least 5 μm of diamond from the nucleation face and forming a sheet or layer of about 200 μm thickness.

The diamond sheet was cut using a Nd:Yag laser to produce a blank of the basic razor blade geometry; in this case a rectangular shape of dimensions 40 mm long and 4 mm wide and 200 μm thick and orthogonally cut edges.

A holder was prepared to hold a stack of these blade blanks at an angle of 70° to the normal of a processing wheel. The blanks were lapped and polished to form asymmetric blades with an effective full angle of 20°.

One of the blades was then mounted into a holder suitable for shaving, and was found to be effective in cutting or shaving hair, and particularly male facial hair, off the skin of a person.

### EXAMPLE 2

One of the blades produced in Example 1 was further processed by laser cutting and then ion beam milling the cutting tip to form a small (approx. 5 μm) secondary facet at an angle of 35° to the nucleation face placed between the primary facet and the cutting edge. The addition of this secondary facet was to increase slightly the effective full angle of the blade at 40 μm from the tip from 20° to about 22°

This blade was then mounted into a holder suitable for shaving, and was found to be effective in cutting or shaving hair, and particularly male facial hair, off the skin of a person. In use, the blade was mounted in a holder such as to ensure that the surface 16 contacts the skin of the person being shaved allowing the cutting edge tip 20 to penetrate and cut through the hairs and not damage the skin of the person being shaved.

### EXAMPLE 3

The method in Example 1 was repeated, but varying the angle at which the blade blanks were mounted during lapping and polishing to form the primary facet. In particular, primary facets at an angle of 15° and 25° from the nucleation face were also produced. Some of the blanks were further processed to form secondary facets described in Example 2.

These blades were each then mounted into a holder suitable for shaving, and found to be effective in cutting or shaving hair, and particularly male facial hair, off the skin of a person.

### EXAMPLE 4

In an alternative form of the invention, a symmetric blade was produced from the blade blanks produced as described in Example 1. The blade blank was mounted with one elongate edge uppermost and two laser cuts down from the top edge used to produce rough symmetric primary facets with a full included angle of 15°. Small secondary facets about 5 μm across were then produced at the tip using ion beam milling, making beneficial use of the edge rounding at the point of laser entry. These secondary facets had a full included angle of about 30° and the resultant effective full-angle at 40 μm from the tip was about 17°.

The blade was suitable for mounting in a conventional razor holder and was found to be effective in cutting or shaving hair off the skin of a person.

### EXAMPLE 5

A sheet of polycrystalline CVD diamond was removed from a tungsten substrate on which it was grown. The sheet had opposite flat and parallel surfaces which were processed by removing the rough growth surface on the diamond using a lapidiary-based technique. Then both sides were polished to a roughness of less than 100 nm Ra, removing at least 5 μm of diamond from the nucleation face and forming a sheet or layer of about 200 μm thickness.

The diamond sheet or layer was cut using a Nd:Yag laser to produce a blank of the basic razor blade geometry; in this case a rectangular shape of dimensions 40 mm long and 4 mm laterally and 200 μm thick. All edges where othogonally cut except the elongate cutting edge which was cut at an angle of 70° to the normal of the plate, forming a cutting edge with an angle of 20° at the exit face of the diamond layer, which was the nucleation side of the diamond film. This laser cut facet was then ion beam milled to form the final cutting surface.

One of the blades was then mounted into a holder suitable for shaving, and was found to be effective in cutting or shaving hair, and particularly male facial hair, off the skin of a person.

### EXAMPLE 6

The method of Example 5 was followed, but the laser cut facet was further processed by mechanical polishing, and then a secondary facet added as described in Example 2.

One of the blades was then mounted into a holder suitable for shaving, and was found to be effective in cutting or shaving hair, and particularly male facial hair, off the skin of a person.

### EXAMPLE 7

The method of Example 5 was followed except that the cutting tip was formed at the growth side of the diamond film.

One of the blades was then mounted into a holder suitable for shaving, and was found to be effective in cutting or shaving hair, and particularly male facial hair, off the skin of a person.

### EXAMPLE 8

A diamond layer was grown on a Si wafer 500 μm thick, to form a layer about 250 μm thick. The growth face of the diamond was then lapped and polished to a roughness of less than 100 nm Ra, forming a diamond layer of about 200 μm thickness.

The diamond layer bonded to the Si wafer was then cut by laser to produce a blank of the basic razor blade geometry; in this case a rectangular shape of dimensions 40 mm long and 4 mm laterally with orthogonally cut edges.

A holder was prepared to hold a stack of these blade blanks at an angle of 70° to the normal of a processing wheel. The blanks were lapped and polished to form asymmetric blades with an effective full angle of 20°. The diamond layer was supported by the Si wafer substrate during the processing. The Si wafer was then removed using a standard Si etch.

A secondary facet was produced between the nucleation face and the cutting edge tip using the method of laser cutting and ion beam milling described in Example 2

One of the blades was then mounted into a holder suitable for shaving, and was found to be effective in cutting or shaving hair, and particularly male facial hair, off the skin of a person.

### EXAMPLE 9

A sheet of polycrystalline CVD diamond was removed from a tungsten substrate on which it was grown. The sheet had opposite flat and parallel surfaces which were processed by removing the rough growth surface on the diamond using a lapidiary-based technique. Then both surfaces were polished to a roughness of less than 100 nm Ra, removing at least 5 μm of diamond from the nucleation face and forming a sheet or layer of about 200 m thickness.

The diamond sheet was cut using a Nd:Yag laser to produce a blank of the basic razor blade geometry; in this case a rectangular shape of dimensions 40 mm long and 4 mm wide and 200 μm thick and orthogonally cut edges.

A holder was prepared to hold a blade blank at an angle of 62° to the normal of a hot metal thinning template. Processing took place in vacuum, with the steel thinning plate maintained at 1080° C., and with the blade under light contact pressure to it until the process stop fabricated into the design of the mount came into contact with the thinning plate. This process produced an asymmetric blade with a single facet and a total effective angle of about 28°. The blade was then further processed using ion beam milling to produce a sharp cutting edge.

The blade was then mounted into a holder suitable for shaving, and was found to be effective in cutting or shaving hair, and particularly male facial hair, off the skin of a person.

1. A blade comprising a layer of CVD diamond have a monolithic elongate cutting edge.

2. A blade according to claim 1 wherein the cutting edge is a straight cutting edge.

3. A blade according to claim 1 or wherein the cutting edge is at least 10 mm in length.

4. A blade according to claim 1 or wherein the cutting edge is at least 20 mm in length.

5. A blade according to claim 1 or which is a razor blade.

6. A blade according to claim 5 wherein the length of the cutting edge is in the range 30 to 45 mm.

7. A blade according to claim 1 wherein the CVD diamond layer has a thickness in the range 50 μm-400 μm.

8. A blade according to claim 7 wherein the CVD diamond layer has a thickness in the range 150 μm-275 μm.

9. A blade according to claim 1 wherein the CVD diamond layer has a rectangular, square or triangular shape.

10. A blade according to claim 5 wherein the effective full angle of the blade at a distance of 40 μm from the cutting edge tip is in the range 12 to 28°.

11. A blade according to claim 5 wherein the effective full angle of the blade at a distance of 40 μm from the cutting edge tip is in the range 15 to 25°.

12. A blade according to claim 5 wherein the effective full angle of the blade at a distance of 40 μm from the cutting edge tip is in the range 17 to 23°.

13. A blade according to claims claim 1 wherein the cutting edge tip has a radius which is less than 60 nm.

14. A blade according to claim 1 wherein the cutting edge tip has a radius of less than 40 nm.

15. A blade according to claim 1 wherein the cutting edge tip has a radius of less than 20 nm.

16. A blade according to claim 1 which is a symmetric blade.

17. A blade according to claim 1 which is an asymmetric blade.

18. (Canceled).

19. (Canceled).
